(19) United States
(12) Patent Application Publication
(10) Pub. No.: US 2010/0043606 A1
(43) Pub. Date: Feb. 25, 2010

(54) HANDHELD TOOL

(76) Inventor: Hsin-Fa WANG, Lu Kang Town (TW)

Correspondence Address: EGBERT LAW OFFICES, 412 MAIN STREET, 7TH FLOOR, HOUSTON, TX, 77002, US

(21) Appl. No.: 12/205,876

(22) Filed: Sep. 7, 2008

(30) Foreign Application Priority Data
Aug. 20, 2008 (TW) 097214908

(51) Int. Cl. B25G 1/00

(52) U.S. Cl. 81/489

(57) ABSTRACT

The present invention provides a handheld tool having a handle, extended into a 3D profile. There is a palm through-hole, being arranged at both sides of the handle and penetrating the handle. The long-shaped palm through-hole is consistent with the long handle, and the pore shape and aperture of the palm through-hole must be suitable for the penetration of a palm. Two first web ribs are formed at two opposite sides of the shorter section of the palm through-hole. The two first web ribs are intended for abutting with the first web of hand. A convex working end is arranged at an extended end of the handle. With this handheld tool, the user can fetch and operate other tools easily while holding this handheld tool, thereby realizing convenient operation with improved applicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a handheld tool, and more particularly to an innovative tool with a palm through-hole and a first web rib as well as a convex working portion.

2. Description of Related Art Including Information Disclosed Under 37 CFR 1.97 and 37 CFR 1.98

There are a variety of handheld tools based on the functions and properties, e.g. shovels, harrows and pushing slabs for gardening applications.

The handheld tools are generally for operation by manually holding the handle. So, the design of the handle shall be well-suited for control in the palm of the user, and this consideration is well recognized by the operators and customers in this service sector. Yet, the handheld tools must still be developed and modified to meet diversified customer requirements.

As a general rule, customers often operate a single-handle tool with only a single hand. However, other tools may also be operated during a task, so the customers have to put down this tool and then fetch another one. If the intended work is to be performed repetitively, this will lead to a time-consuming and inconvenient work issue.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

There is enhanced efficacy of the present invention.

Based on the innovation of the present invention, a handle has a palm through-hole and first web ribs. The user can fetch and operate other tools easily while holding this handheld tool, thereby meeting the diversified customer requirements with improved applicability.

There are improvements brought about by this invention.

Based on another structure, the convex working portion of the handheld tool of the present invention enables assembly of tool heads. The convex working portion can be used for assembly and replacement of other tool heads, thus realizing various functions with improved applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 depicts a perspective view of the preferred embodiment of the present invention.

FIG. 2 depicts a perspective view of the operation of the present invention.

FIG. 3 depicts another perspective view of the operation of the present invention.

FIG. 4 depicts a perspective view of another application of the present invention.

FIG. 5 depicts a perspective view of still another application of the present invention.

FIG. 6 depicts a perspective view of a changed structure in FIG. 5.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

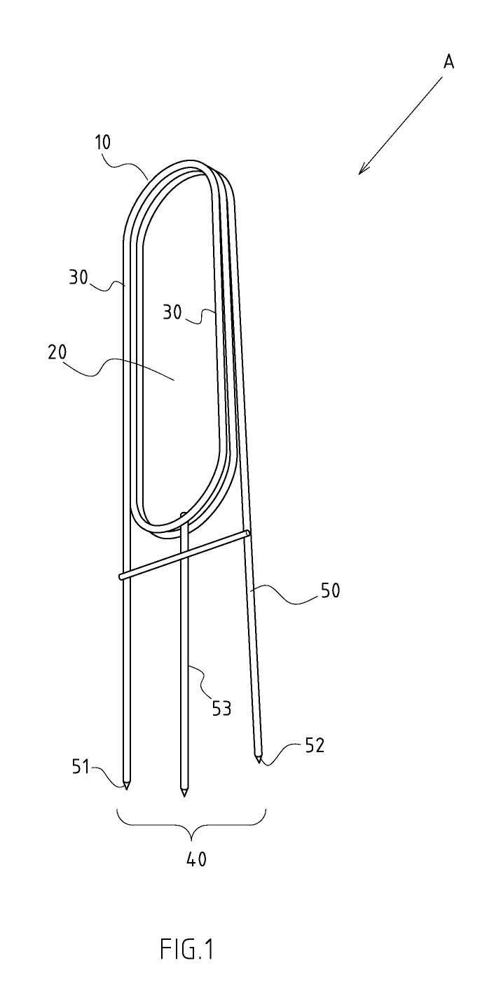

FIG. 1 depicts a preferred embodiment of a handheld tool of the present invention. The embodiment is provided only for explanatory purposes with respect to the claims.

The handheld tool A for gardening purposes comprises a handle 10, extended into a 3D profile.

A palm through-hole 20 is arranged at both sides of the handle 10, penetrating the handle 10. The long-shaped palm through-hole 20 is designed in consistent with the long handle 10, and the pore shape and aperture of the palm through-hole 20 must be suitable for the penetration of a palm and four fingers.

Two first web ribs 30 are formed at two opposite sides of the shorter section of the palm through-hole 20. These two first web ribs 30 are intended for abutting with the first web of hand.

A convex working end 40 is arranged at an extended end of the handle 10. The convex working end 40 of the preferred embodiment is designed into a bar-like harrow.

Referring to FIG. 1, the handheld tool A of the present invention is made of a metal bar 50, which is folded into a long ring defining the palm through-hole 20 and two first web ribs 30. Two ends 51, 52 of the metal bar 50 protrude from the long ring. One end of the long ring of the metal bar 50 is welded with the other metal bar 53, thus defining the convex working end 40 along with two ends 51, 52.

Based on above-specified structures, the present invention is operated as follows:

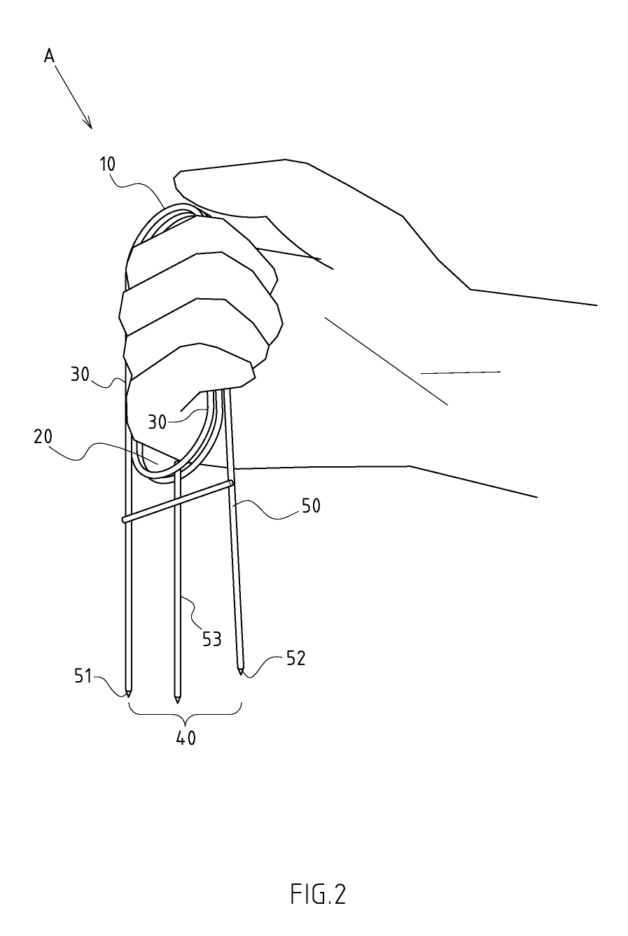

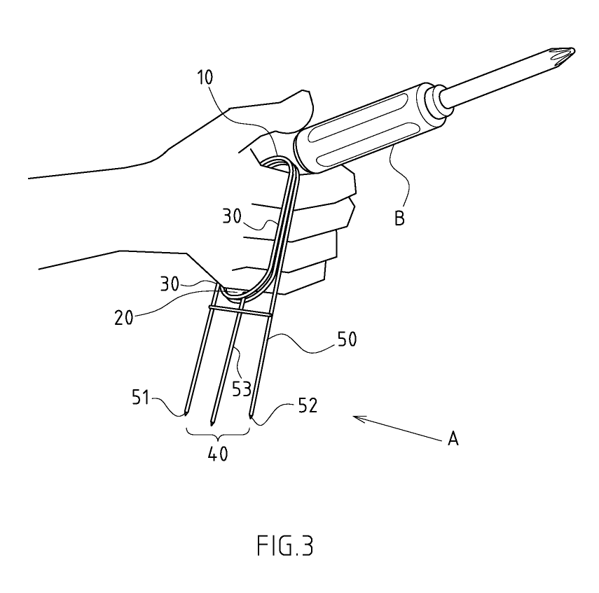

Referring to FIG. 2 for tool A, the human hand may penetrate through the palm through-hole 20 of the handle 10, and then a finger holds either of first web ribs 30 for operation (the bar-like convex working end 40 can be used for scarification. Referring also to FIG. 3, when the user intends to fetch another tool (indicated by B in FIG. 3) while holding the tool A, he/she is just required to move the first web ribs 30 of the handle 10 towards the first web without putting down tool A, thus providing a sufficient space between the thumb and four fingers, and enabling operation of other tools easily while holding tool A.

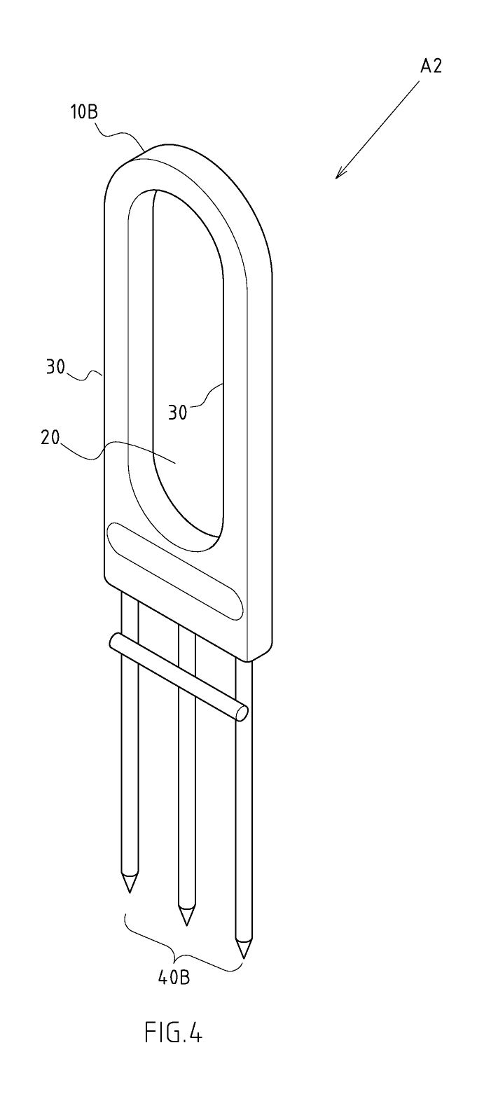

Referring also to FIG. 4 for tool A2, the handle 10B is integrally made of plastic or timber or metal materials. The convex working end 40B is made of single or a plurality of metal bars.

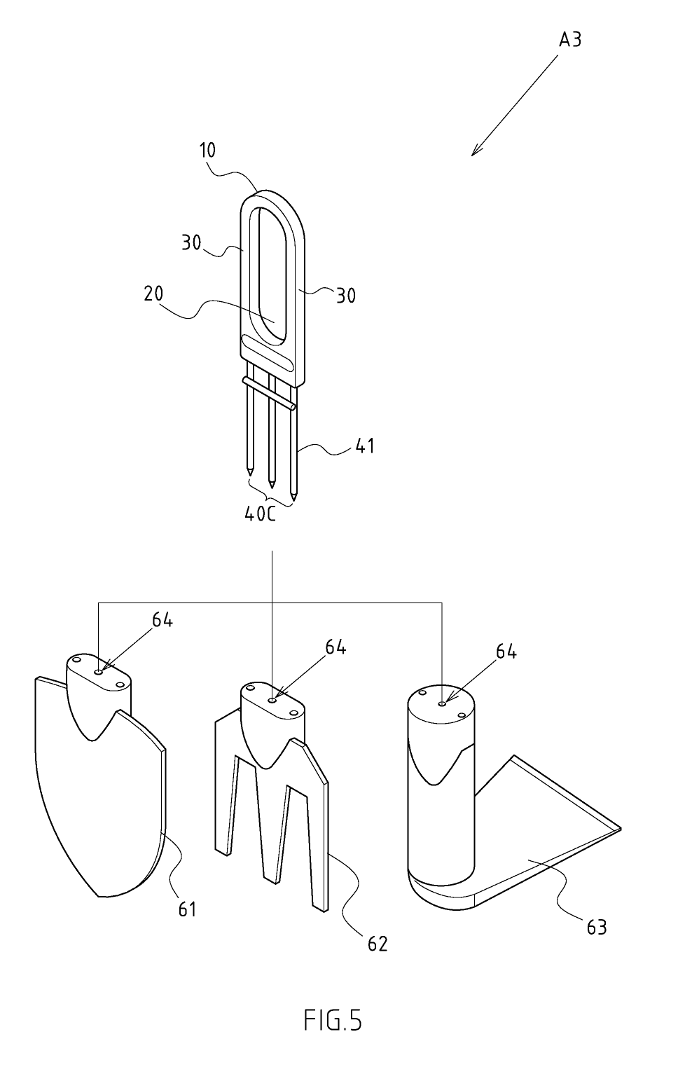

Referring also to FIG. 5, tool A3 is also provided with a convex working end 40C for assembly of tool heads. In addition, at least a combined set of tool heads 61, 62, 63 is arranged, at one end of which is provided with a concave assembly portion 64 for sleeving onto the convex working end 40C for replacement of tool heads. The convex working end 40C is made of a plurality of spaced rods 41, so that the concave assembly portion 64 of the combined tool heads 61, 62, 63 is provided with a plurality of spaced holes.

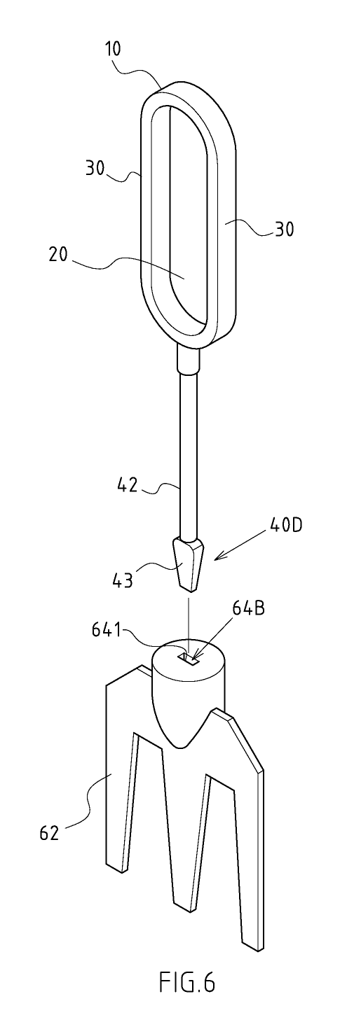

Referring also to FIG. 6, the convex working end 40D is also made of a single pole 42. An orientation flange 43 is formed at the end of the pole, so that the concave assembly portion 64B of the combined tool head 62 is provided with a single slot. An orientation mating portion 641 is formed in the slot-shaped concave assembly portion 64B for mating with the orientation flange 43 of the pole 42 for directional positioning purpose.

1. A handheld tool, comprising:
a handle, extended into a 3D profile;
a palm through-hole, being arranged at both sides of said handle and penetrating the handle, said palm through-hole being consistent with said handle and having a pore shape and penetrable aperture;
two first web ribs, formed at two opposite sides of a shorter section of the palm through-hole, being an abutment; and
a convex working end, arranged at an extended end of said handle.

2. The tool defined in claim 1, wherein said handle is comprised of a metal bar, being folded into a ring defining the palm through-hole and two first web ribs, said metal bar having two ends protruding from the ring and defining the convex working portion.

3. The tool defined in claim 1, wherein the handle is integrally made of plastics or timber or metal materials, the convex working portion being made of metal bars.

4. The tool defined in claim 1, wherein the convex working portion is a bar-like harrow.

5. A handheld tool, comprising:
a handle, extended into a 3D profile;
a palm through-hole, being arranged at both sides of said handle and penetrating the handle, said palm through-hole being consistent with said handle and having a pore shape and penetrable aperture;
two first web ribs, formed at two opposite sides of a shorter section of the palm through-hole, being an abutment; and
a convex working end allowing for assembly of tool heads, arranged at an extended end of the handle; and
a combined set of tool heads, having one end provided with a concave assembly portion sleeved onto the convex working end.

6. The tool defined in claim 5, wherein said handle is comprised of a metal bar, being folded into a ring defining the palm through-hole and two first web ribs, said metal bar having two ends protruding from the ring and defining the convex working portion.

7. The tool defined in claim 5, wherein the handle is integrally made of plastics or timber or metal materials, the convex working portion being made of metal bars.

8. The tool defined in claim 5, wherein the convex working portion is comprised of a plurality of spaced rods, the concave assembly portion being provided with a plurality of spaced holes.

9. The tool defined in claim 5, wherein the convex working portion is comprised of a single pole, having an end with an orientation flange, the concave assembly portion of the combined tool head being provided with a single slot, the concave assembly portion being slot-shaped and having an orientation mating portion and mating with the orientation flange of the pole.

10. (canceled)
